(19) United States
(12) Patent Application Publication
(10) Pub. No.: US 2013/0126405 A1
(43) Pub. Date: May 23, 2013

(54) OIL/WATER FILTRATION DEVICE

(71) Applicants: Holger Weitze, Korschenbroich (DE); Johannes Sinstedten, Korschenbroich (DE); Herbert Schlensker, Leverkusen (DE)

(72) Inventors: Holger Weitze, Korschenbroich (DE); Johannes Sinstedten, Korschenbroich (DE); Herbert Schlensker, Leverkusen (DE)

(73) Assignee: BEKO TECHNOLOGIES GMBH, Neuss (DE)

(21) Appl. No.: 13/579,868

(22) PCT Filed: Feb. 25, 2011
(86) PCT No.: PCT/EP11/52857

§ 371 Date: Aug. 17, 2012

(30) Foreign Application Priority Data
Feb. 26, 2010 (DE) 10 2010 002 431.7

(51) Int. Cl. C02F 1/40

(52) U.S. Cl. CPC C02F 1/40
USPC 210/137; 210/252; 210/138; 210/259; 210/258

(57) ABSTRACT

The invention relates to an oil/water separating device (20) comprising a main filter (30) for removing oil-containing components from an oil/water mixture. The device is characterized by an additional mechanical separating device for removing slimy substances from the oil/water mixture.

### FIELD

The invention relates to an oil/water separating device.

### BACKGROUND

Oil/water separating devices are frequently used in connection with air compressors. Air compressors produce compressed air by sucking in and compressing ambient air. The air humidity contained accumulates as condensate due to physical reasons and due to the compressed air being dried. This condensate is waste water which, owing to the introduction of lubricants by the air compressor, most frequently is not permitted to be discharged into the public sewer because it exceeds the hydrocarbon concentration limits.

Given a volume flow of 60 m³/h sucked-in air, a mostly discontinuous condensate flow of 1.6 l/h charged with 300 mg/h oil may be produced; this corresponds to 190 ppm.

Depending on the climatic conditions (ambient temperature and humidity), the type of oil used, design and operation of the compressor etc., these values may fluctuate.

The bond between water and the lubricant also varies and ranges from mixtures of oil and water over dispersions to emulsions. Admissible values for discharge into the sanitary sewer are 20, or 10, in part 5 ppm (parts per million). Thus, a special waste is produced which has to be expensively disposed of by a waste disposal company, even though 99.5% percent of it is water from ambient air humidity.

The object of commercially available oil/water separating devices is to process the condensate on-site so that it can be discharged, i.e. to remove the oil contents from the water in a cost-effective manner. Known apparatuses of this design usually employ several separating stages in order to achieve the desired purity.

The condensate is discharged slowly and thus, with little turbulence, via a pressure relief element into a preseparator. The latter works according to the principle of gravity separation and provides for the deposition of heavy, sedimentary contaminants (density greater than 1 kg/dm³) and the floating of free oil contents (density lower than 1 kg/dm³), which then flow into a receiving container. In a second stage, fine oil droplets are separated from the condensate by means of adsorption filters, which are mostly based on oleophilic material and active carbon with a very large internal surface.

In another design according to the prior art, the condensate, together with the free oil contents, is fed through the adsorption filter, which in turn floats on the condensate surface and soaks up oil contents that deposit here (density greater than 1 kg/dm³). The construction works according to the principle of the corresponding water column; processed condensate leaves the apparatus at the treated-water outlet in the direction towards the sewer in the same extent that new condensate flows in.

The collected free oils and the oil-saturated filters are usually thermally utilized, but may also be treated.

Strongly dispersed or even emulsified condensates cannot be treated in these apparatuses and are usually treated by more complex methods, e.g. by membrane, evaporation or decomposition processes.

In practical use, there is occasionally the problem of filters or oil/water separating devices becoming blocked without the corresponding entry of oil, i.e. by additional foreign materials. The reason for this is the existence of bacteria, algae or fungi in the condensate. This is frequently caused by the installation conditions for the systems, e.g. in fruit juice companies, or the operating conditions, e.g. a high machine capacity utilization. An important cause also includes the lubricating oils and their use; modern lubricating oils for air compressors are used for very much longer and contain fewer and fewer bactericidal additives such as, e.g. softeners.

Due to the operational residence time in the oil/water separating devices, bacteria, algae and fungi produce a slime that partially deposits on the water surface, but also sinks and sediments or remains suspended. When flowing through the filtration stages, it can deposit on their surfaces and then leads to a blocking which, due to the operationally low admission pressure, no longer permits condensate to pass through. The apparatus then runs over, and the operating life of the filters is thus unacceptably reduced, e.g. from at least 6 months to 6 weeks.

### SUMMARY

An exemplary embodiment of the present invention to provides an oil/water separating device which has a long operating time even when slime-like substances accumulate in the mixture to be separated. At the same time, the oil/water separating device is supposed to have a simple design and be cost-effective to produce.

An exemplary embodiment of the invention achieves desirable results via an oil/water separating device which is characterized by an additional mechanical separating device for separating slime-like substances from an oil/water mixture.

For the purpose of simplification, the term oil/water mixture will be used below for the liquid that is conducted through the separating device, irrespective of the content of oil or the oil constituents in the liquid. Thus, the term also relates to the liquid behind the filter elements in the flow direction.

An exemplary embodiment of the invention is based on the insight that a bactericidal treatment of the condensate, which at first appears obvious and even advantageous, is disadvantageous for several reasons. The introduction of additional harmful substances into the condensate, i.e. into the waste water, leads to a load on downstream sewage plants. Moreover, defining a suitable agent is difficult because the conditions of every application are different. A complete elimination is also difficult; due to the subsequent residence times in the oil/water separating devices, the residues of bacteria, fungi or algae will again grow to problematic magnitudes. Furthermore, such methods most frequently require a more complex plant technology, e.g. for backwashing, which then would be disproportionate to the simplicity of commercially available oil/water separating devices.

In an exemplary embodiment, the invention advantageously prevents the development of slime-like substances, but rather in designing the oil/water separating device in such a way that it is capable of compensating for or withstanding the development or an increased accumulation of slime-like substances without the operating time being substantially limited. This solution contradicts the common prejudice that a mechanical separation of such substances is hardly possible, or possible only with an increased effort.

According to an exemplary embodiment of the invention, the separating device for separating the slime-like substances from the oil/water mixture can be formed by different systems.

The following embodiments have proven particularly advantageous:
Upstream filter element;
Integrated filter element,
Filtration with a flow regulator,
Filtration with ventilation,
Filtration with ventilation and sedimentation separation,
Filtration with sedimentation separation,

All embodiments have in common that the slime entering the separating device is filtered and retained.

The advantage of an upstream filter element, i.e. a filter element disposed outside the housing of a main filter, lies in the fact that it can be cleaned and replaced independently from the separating device or the main container.

In all the embodiments, the filtration or separation of the slime serves for keeping clear or slowing down the blocking of the main filter which separates the oil from the oil/water mixture. For this reason, the separation of the slime always takes place prior to the separation of the oil or the oil-containing components from the oil/water mixture.

The utilization of a sucking or pressing pump as a flow regulator in connection with a slime filter has the great advantage that the blocking of the filter elements is hardly possible or is slowed down significantly. In any way, the aim is to always maintain the flow-through of oil/water mixture given for the conventional oil/water separator, which is why the pump is considered a flow regulator. This results in significantly higher operating lives for the separating device. This is particularly advantageous in cases where regular maintenance intervals are scheduled and a replacement of the filter elements is to be avoided in between the scheduled maintenance dates. The pump can be level-controlled or time-controlled. Level control means that the pump switches on if a corresponding filling quantity is reached in the separating device. Alternatively, and in particular in the case of a regular feed into the separating device, the pump can also be switched on after certain intervals. A combination of the two options is also conceivable.

Another essential advantage owed to the use of the pump lies in the fact that the pump is able to deliver in the reverse direction and that thus, the separating device can be cleaned by backwashing.

A nonwoven fabric is particularly suitable as a filter material because it has only a very low flow resistance while having a large surface area at the same time.

The integration of ventilation means that a gas is supplied which moves or entrains sediments in the direction opposite to the flow direction of the oil/water mixture. It is thus avoided that the main filter, which is supposed to remove the oil-containing constituents from the oil/water mixture, becomes clogged with sediment; at least the blocking of the main filter is slowed down. In addition to the ventilation, special sediment spaces can be provided in which sediment can settle. A combination of nonwoven fabric, ventilation and sediment space is also possible.

### BRIEF DESCRIPTION OF THE FIGURES

Various exemplary embodiments are explained below with reference to the following description of the figures.

In the figures:

FIG. 1: shows a first variant of an oil/water separating device according to an exemplary embodiment of the invention with an upstream filter element,

FIG. 2: shows a second variant of an oil/water separating device according to an exemplary embodiment of the invention based on deep-bed filtration,

FIG. 3: shows a third variant of an oil/water separating device according to an exemplary embodiment of the invention based on deep-bed filtration with suction,

FIG. 4: shows a fourth variant of an oil/water separating device according to an exemplary embodiment of the invention with ventilation,

FIG. 5: shows a fifth variant of an oil/water separating device according to an exemplary embodiment of the invention with ventilation and a sedimentation separator,

FIG. 6: shows a sixth variant of an oil/water separating device according to an exemplary embodiment of the invention with a sedimentation separator and a nonwoven fabric,

FIG. 7: shows a second variant of an oil/water separating device according to an exemplary embodiment of the invention with a sedimentation separator and a nonwoven fabric,

FIG. 8: shows a seventh variant of an oil/water separating device according to an exemplary embodiment of the invention with ventilation and a sedimentation separator and a nonwoven fabric,

FIG. 9: shows an eighth variant of an oil/water separating device according to an exemplary embodiment of the invention with an integrated filter element,

FIG. 10: shows a ninth variant of an oil/water separating device according to an exemplary embodiment of the invention with an integrated filter element and a multi-stage main filter.

### DETAILED DESCRIPTION

The following Figures show different variants of an oil/water separating device 20 according to an exemplary embodiment of the invention. It has a housing 23.

In a first embodiment according to an exemplary embodiment of the invention, a filter element 22 which removes slime-like substances from an oil/water mixture is provided in the feed of a commercially available oil/water separating device 20, or of the housing 21 thereof. It was found that such a filter element 22 can preferably be formed of an aluminum foam coated with nanosilver; however, it can basically be formed of, or at least include, any material that has germicidal properties. For example, the filter element 22 can consist of a housing in which D45 discs are disposed in a stack and which has a volume of 0.2 to 0.5 liters. The mixture is fed under pressure and at an increased speed, whereby the filter element 22 remains clear and is not clogged over a long period of time owing to the only short residence time of the mixture within the filter element 22.

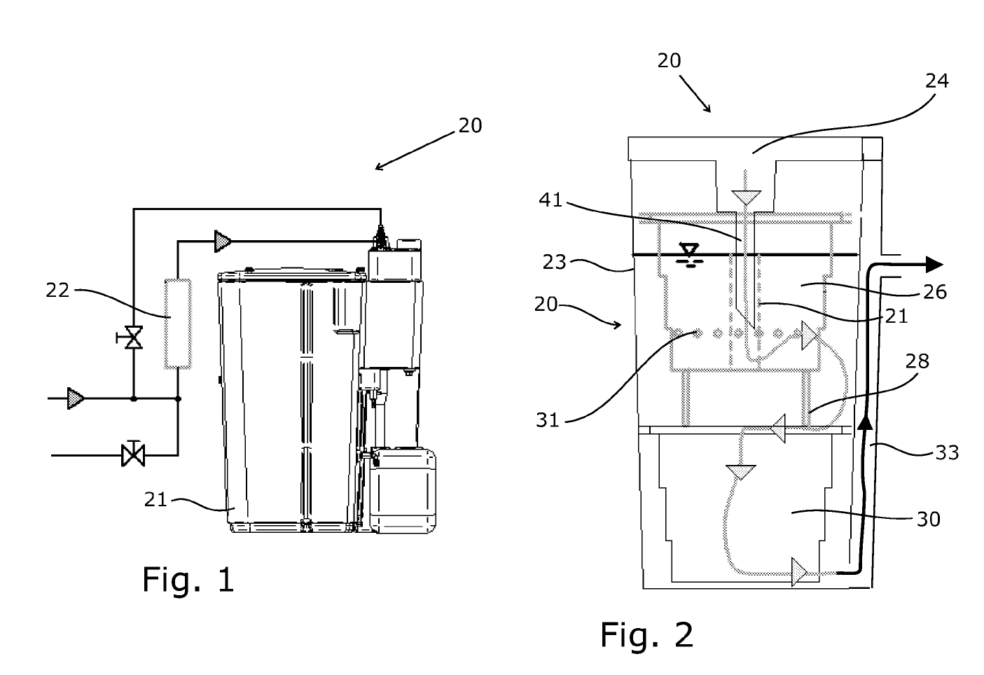

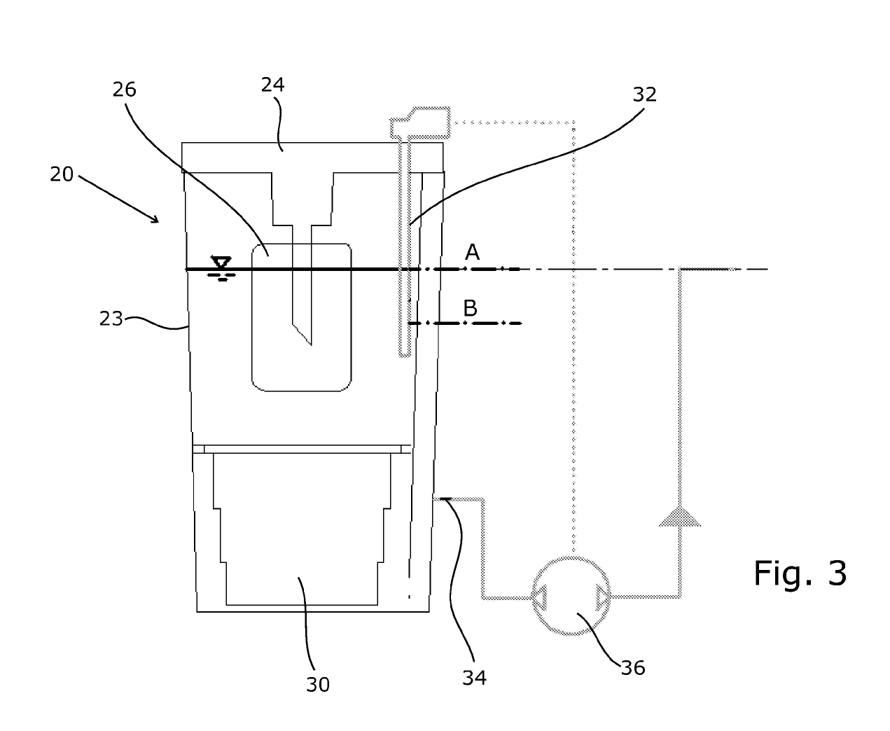

FIG. 2 shows another variant according to an exemplary embodiment of the invention in which filtration takes place within the oil/water separating device 20. The liquid takes the flow path 41. First, the oil/water mixture is conducted through a cap 24 into a pre-filter 26 through a central screening tube 21. In the process, the cap 24 also serves as a hold-down device for the inner pre-filter 26. A nonwoven filter material, which is configured as a spun yarn and retains the slime at least to a large extent, is preferably provided within the pre-filter 26. The nonwoven filter fabric is replaceable and can preferably be reused after having been cleaned. A substantial advantage of such a nonwoven filter fabric also lies in the fact that is has an only small flow resistance. This embodiment can additionally comprise the filter element 22 shown in FIG. 1.

The pre-cleaned liquid exits the pre-filter 26 through pre-filter openings 31 and enters a main filter 30 which is separated from the pre-filter 26 by one or more spacers 28. The spacer(s) 28, among other things, cause the pre-cleaned liquid to collect and settle prior to entry into the main filter 30. Oil separation then takes place in the subsequent main filter 30. The cleaned liquid is conducted out of the oil/water separating device 20 via a riser 33.

FIG. 3 shows an embodiment in which the oil/water separating device 20 according to an exemplary embodiment of the invention for the separation of slime-like substances from the oil/water mixture is formed by a pump 36 combined with a level detecting device 32. The pump 36 is connected to the oil/water separating device 20 via a corresponding conduit through a connection 34 in the flow direction behind the main filter 30. The oil/water mixture is sucked in through the pump 36, which increases the operating time of the oil/water separating device 20 in the case of an accumulation of slime-like substances. The level detecting device 32 is provided in order to avoid that the liquid level within the oil/water separating device 20 drops below the pre-filter 26. As soon as the level within the oil/water separating device 20 becomes too low, the pump 36 switches off. The pump capacity in this case corresponds to about one to two times the nominal capacity of the oil/water separating device 20. Level limits A, B are depicted by way of example.

Alternatively, it is also possible according to an exemplary embodiment of the invention to control or regulate the pump 36 in a time-dependent manner. This is possible without any trouble particularly if the feed quantity into the oil/water separating device 20 per unit of time is known. The level detecting device 32 can still be provided as a back-up system; in a simple variant, however, the level detecting device 32 can be omitted completely.

A substantial advantage of using the pump 36 lies in the fact that its capacity can be adapted to different conditions on-site or to contaminations of the liquid. By using the pump 36, it is possible, without any problems, to overcome the flow resistance resulting from the filter(s) 26, 30. Due to this mode of operation, the same amount of oil/water mixture per unit of time is treated as in a simple oil/water separator of identical capacity. Thus, the load, design and mode of operation of the apparatus remains the same; the pump thus merely works as a flow regulator in the case of an impairment by slime-like substances.

In another alternative embodiment, a pressing pump 36, which is then disposed before the filters 26, 30, seen in the flow direction, can be used instead of a sucking pump 36.

According to an exemplary embodiment of the invention, it is also possible to use the embodiment according to FIG. 1 with a pump 36.

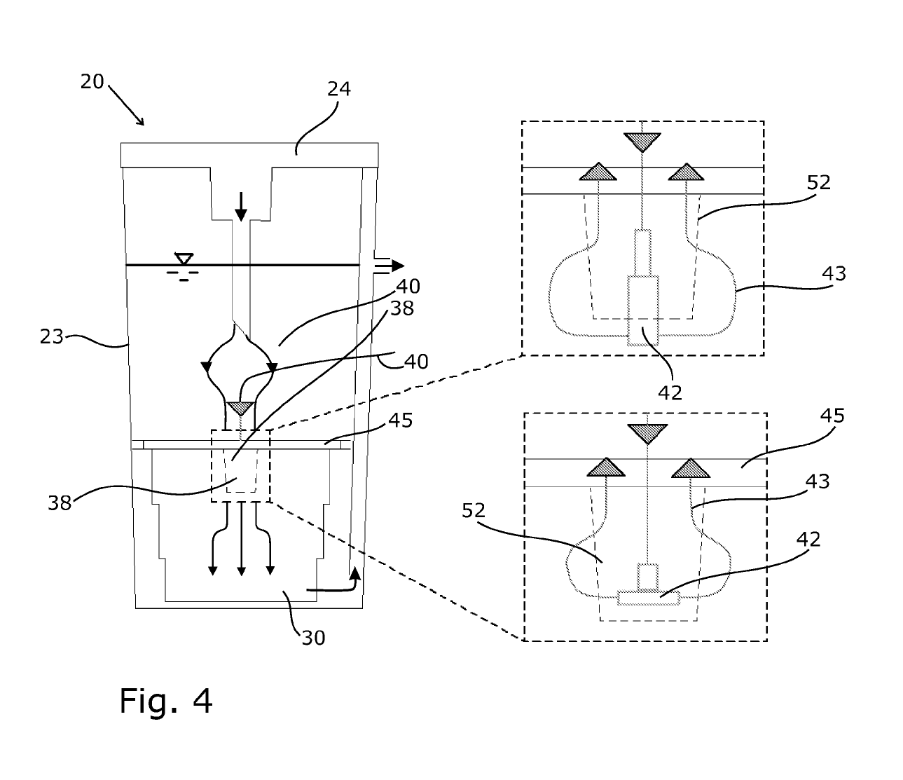

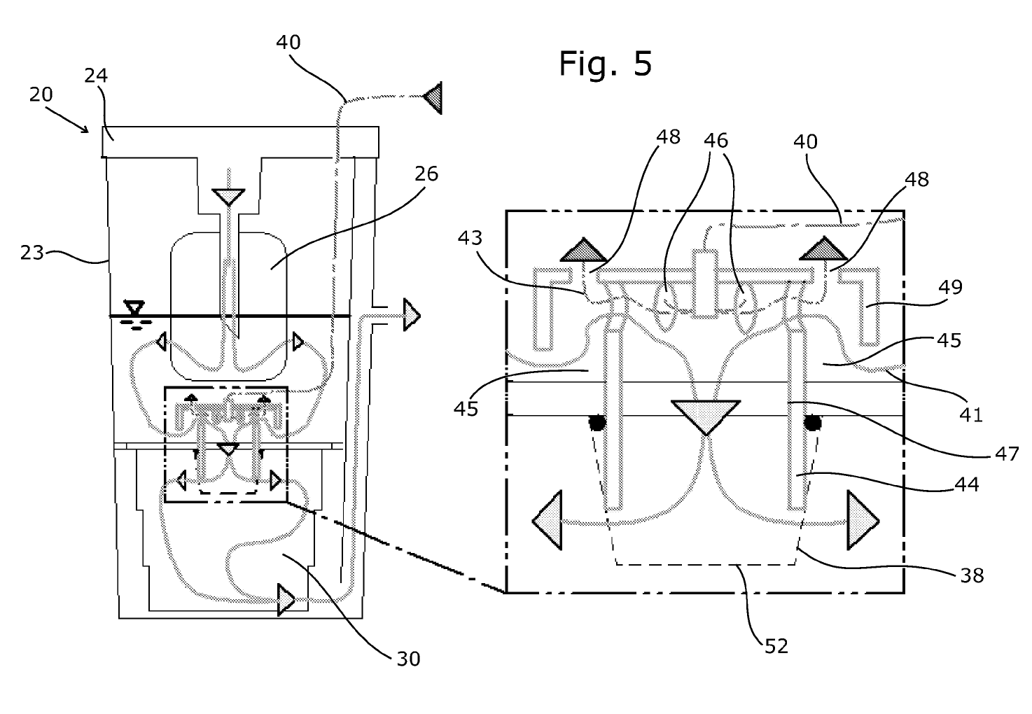

In the embodiment according to an exemplary embodiment of the invention in accordance with FIG. 4, the separating device for the slime-like substances if formed by a ventilation element 42. A gas, for example compressed air, is conducted via a ventilation pipe 40 to the ventilation element 42 and escapes there. The ventilation element 42 is disposed within a filter cup 52 located in the area of the main filter 30 below a division plate 45. The introduced gas escapes from the ventilation element 42 and flows upwards through the filter container 52 and the division plate 45, whereby slime-like substances are entrained and kept away from the main filter (30). The entrainment or swirling of the slime-like substances against the flow direction of the oil/water mixture prevents flow openings of the main filter 30 or the main filter 30 itself from becoming clogged. A gas flow 43 is depicted as an arrow. The feed of the gas is also possible via a perforated tube. Two different ventilation elements 42 are shown; the gas escapes from both of them laterally. The shape of the ventilation element 42 can be adapted to the respective design of the oil/water separating device 20. The oil/water mixture enters the main filter 30 through the main filter inlet 38, the cleansed liquid then leaves the oil/water separating device 20 via the riser 33.

FIG. 5 shows a fifth variant of an oil/water separating device 20 according to an exemplary embodiment of the invention, including the ventilation system already explained, but with an additional a sedimentation separating element 44. The sedimentation separating element 44 causes slime-like material, which sinks if the buoyancy force of the ventilation is insufficient, to remain in the sediment space 45 and to not settle on the main filter inlet 38, so that the main filter inlet 38 is kept clear even over long operating times. The basic construction approximately corresponds to the construction of the device according to FIG. 4, only a sedimentation separating element 44 is additionally inserted. It is formed by a pipe 47 sealed by a shield 49. The gas is fed through the shield 49 via the ventilation pipe 40 and escapes again in a downward direction through the pipe and through pipe openings 46. Moreover, shield openings 48 which also serve for draining off the gas are provided within the shield 49. One advantage of this embodiment lies in the fact that the sediment space 45 can be cleaned easily and without replacing the main filter 30.

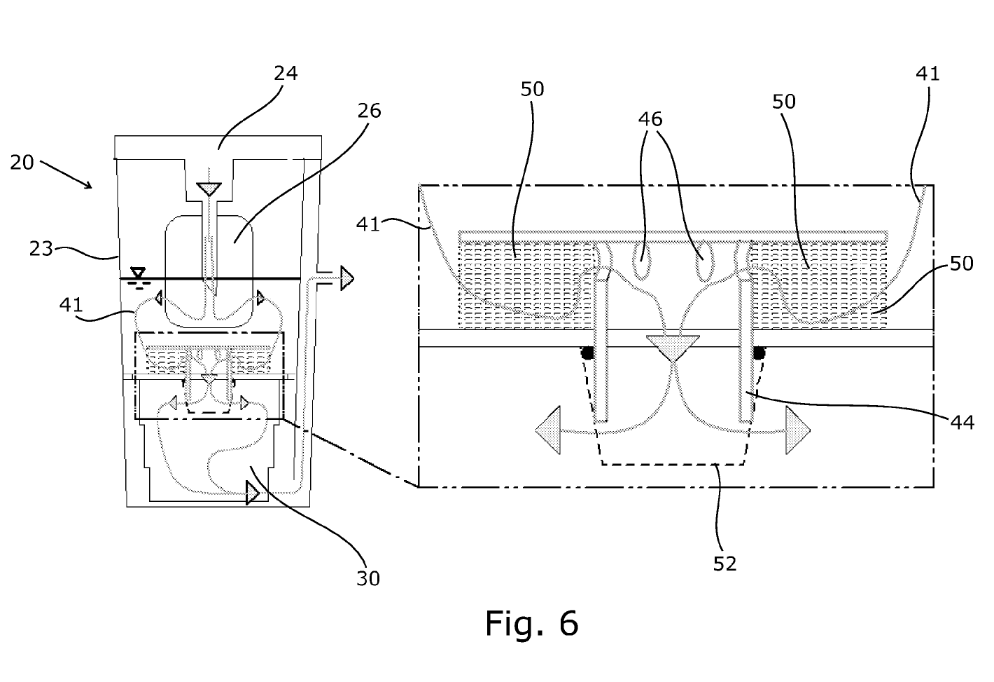

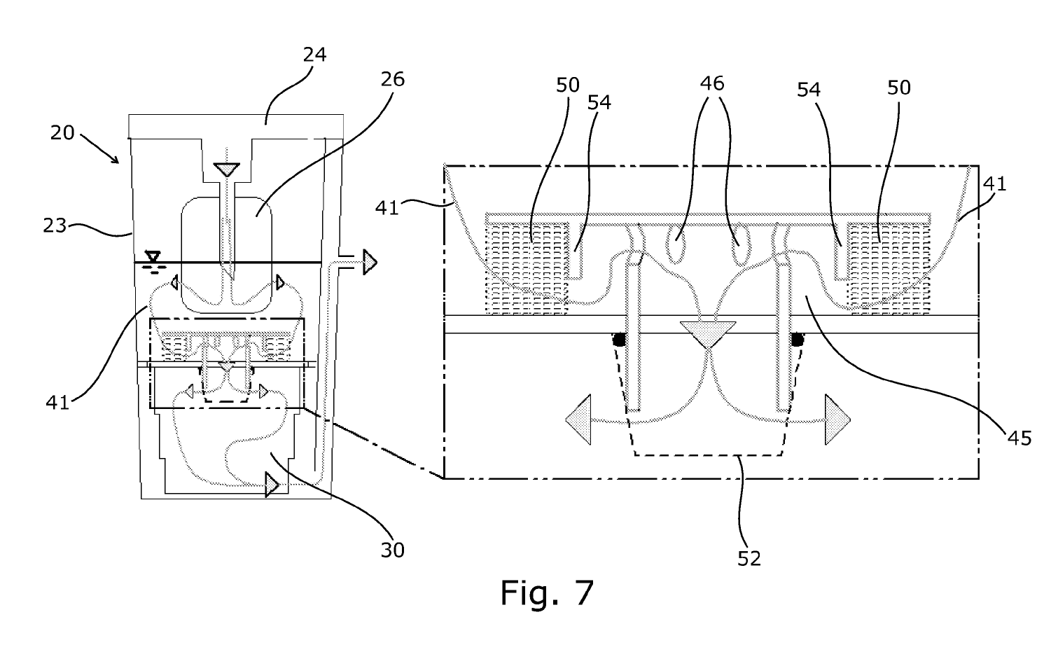

FIGS. 6 to 8 show oil/water separating devices 20 that comprise a sedimentation separating element 44 and, additionally, a nonwoven fabric 50. The oil/water mixture is conducted through the nonwoven fabric 50 into the main filter 30. The nonwoven fabric binds the slime. In the embodiment according to FIG. 7, a sediment space 45 in which material can deposit is provided in addition to the nonwoven fabric 50. Express reference is made to the fact that these variants can also be combined with the flow regulator shown in FIG. 3, i.e. with the pump 36.

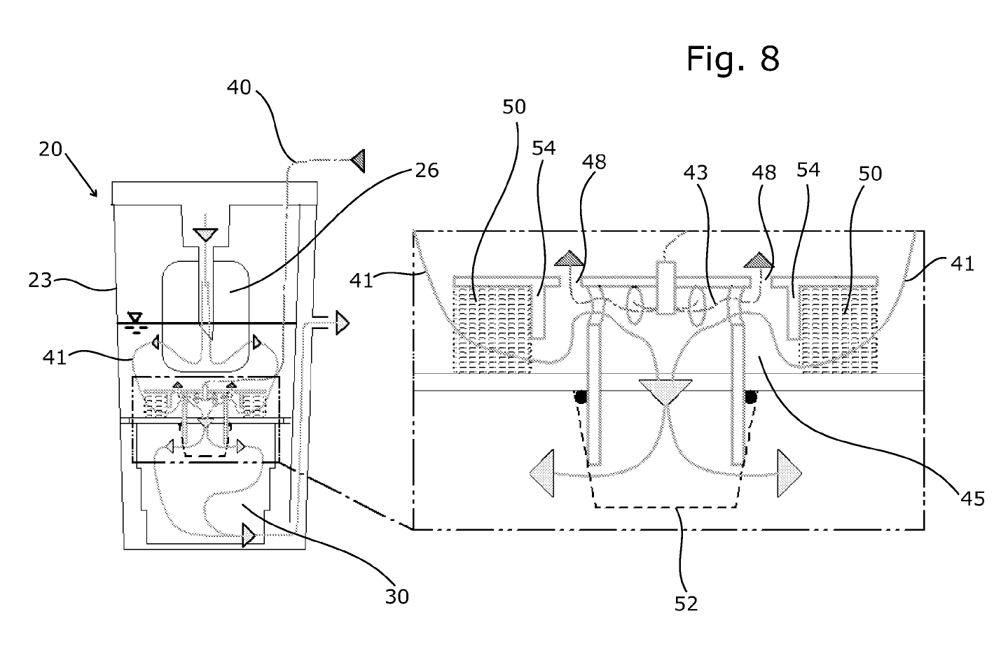

In the embodiment according to FIG. 8, the ventilation, which was already described, is furthermore provided. Also in this case, the gas flow escapes through the pipe openings 46 and the shield openings 48. According to the embodiments of the FIGS. 7 and 8, the nonwoven fabric 50 comes to rest against a vertical wall 54. A sediment space 45 is provided also in this embodiment.

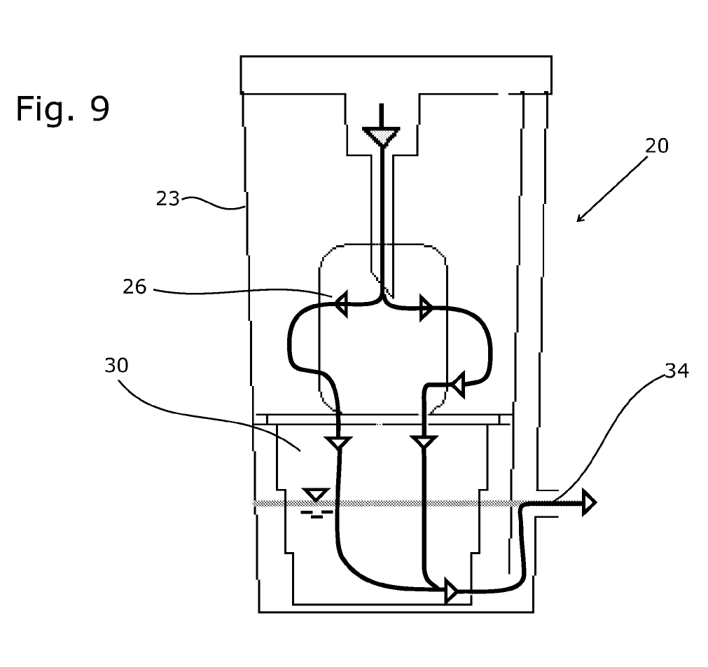

Finally, FIG. 9 shows another embodiment of an oil/water separating device 20 according to an exemplary embodiment of the invention, in which the filtered oil/water mixture drains off at as low a point as possible of the oil/water separating device 20, so that a higher pressure level within the oil/water separating device 20 is produced when the main filter 30 is becoming blocked. Thus, the mixture to be separated is pressed through the slime-like substances.

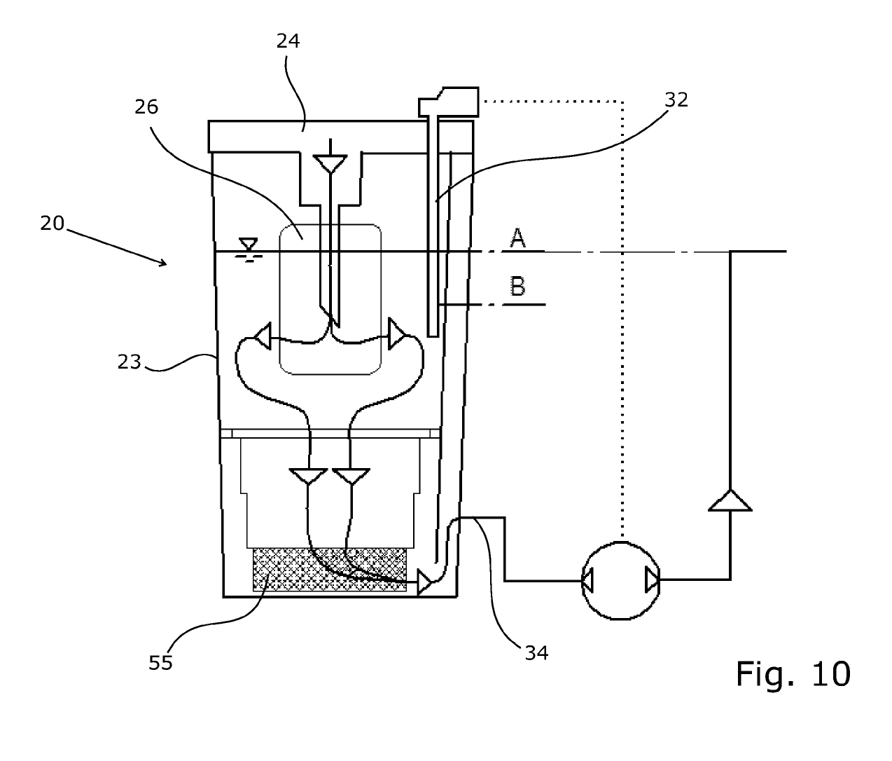

Advantageously, the main filter 30 can also be of a multi-stage design in all of the above-described embodiments; FIG. 10 shows a preferred exemplary embodiment. This makes sense particularly if emulsions have to be separated, which in the worst case even accumulate in different amounts over time. It was found that the main filter 30 can comprise, for example, a second filter stage 55 consisting of alkene or oleofinic, oil-adsorbing material. Attapulgite or Fuller's earth, for example, are suitable; these substances filter out even the smallest emulsified oil contents.

The two filter stages can be realized separately from each another; however, they can also be combined with each other in a single filter stage. In the latter variant, the two filtration processes take place within a single filter stage. If two filter stages are realized, then they can be immediately adjacent to each other, i.e. be in contact with each other; however, they can also be separated from each other by a screen-like layer. Such a screen can consist of any suitable material. In a particularly advantageous embodiment, the various filter stages can also be replaced independently from one another, which is also facilitated by a screen located between them. The multi-stage construction of the main filter 30 is particularly suitable for use with a sucking or pressing pump because the latter pulls or presses the oil/water mixture through the main filter even if that is blocked by, for example, bacteria on its outer face.

The invention is not limited to the embodiments shown but also includes, in particular, combinations of the different possibilities for the separation and deposition of the slime-like substances.

1. An oil/water separating device comprising:
a main filter for removing oil-containing constituents from an oil/water mixture, characterized by an additional mechanical separating device for separating slime-like substances from the oil/water mixture.

2. The oil/water separating device according to claim 1, wherein the mechanical separating device is formed by a filter element disposed in the feed outside a housing of the oil/water separating device.

3. The oil/water separating device according to claim 1, wherein the mechanical separating device is formed by a pre-filter disposed within the housing of the oil/water separating device.

4. The oil/water separating device according to claim 2, wherein the filter element and/or the pre-filter comprises germicidal material.

5. The oil/water separating device according to claim 1, wherein a flow regulator delivers the oil/water mixture.

6. The oil/water separating device according to claim 5, wherein the flow regulator, seen in the flow direction, is disposed before of the housing of the oil/water separating device.

7. The oil/water separating device according to claim 5, wherein the flow regulator, seen in the flow direction, is disposed behind the housing of the oil/water separating device.

8. The oil/water separating device according to claim 5, wherein the flow regulator is controlled by a level detecting device measuring the liquid level within the housing.

9. The oil/water separating device according to claim 5, wherein the flow regulator is controlled in a time-dependent manner.

10. The oil/water separating device according to claim 1, wherein a pre-filter that retains slime-like material from the oil/water mixture is provided within the housing before the main filter seen in the flow direction.

11. The oil/water separating device according to claim 1, wherein the main filter is configured in such a way that it is suitable for separating emulsified oil/water mixtures.

12. The oil/water separating device according to claim 11, wherein the main filter is formed in multiple stages.

13. The oil/water separating device according to claim 3, wherein a ventilation is provided via which a gas flow, which keeps slime-like substances away from the main filter, is introduced into the housing.

14. The oil/water separating device according to claim 13, wherein a sedimentation separating element with a sediment space is provided, wherein slime-like material that sinks if the buoyancy force of the ventilation is insufficient remains in the sediment space.

15. The oil/water separating device according to claim 5, wherein the flow regulator is configured as a pump.
